(19) United States
(12) Patent Application Publication
(10) Pub. No.: US 2001/0034420 A1
(43) Pub. Date: Oct. 25, 2001

(54) Thermoplastic resin composition, process for producing the same and molded product using the same

(76) Inventors: Ken Honma, Hiratsuka-shi (JP); Satoshi Kanayama, Hiratsuka-shi (JP); Tatsuhiko Hatakeyama, Hiratsuka-shi (JP); Kenichi Narita, Hiratsuka-shi (JP)

Correspondence Address: David G. Conlin, Esquire, Dike, Bronstein, Roberts & Cushman, LLP, 130 Water Street, Boston, MA, 02109, US

(21) Appl. No.: 09/769,784

(22) Filed: Jan. 25, 2001

(30) Foreign Application Priority Data
Jan. 26, 2000 (JP) 2000-16823

(51) Int. Cl. C08F 20/00

(52) U.S. Cl. 525/439

(57) ABSTRACT

The present invention relates to a thermoplastic resin composition comprising:

(A) 100 parts by weight of a copolyester resin,

(B) 0.001 to 1 part by weight of a Lewis acid compound, a basic compound or mixture thereof, and

(C) 200 to 1,000,000 parts by weight of a polycarbonate resin,

the morphology of said thermoplastic resin composition comprising a continuous phase and a discontinuous phase dispersed in said continuous phase, and

said discontinuous phase having a size of 1 to 500 nm, when observed by transmission electron microscope.

### BACKGROUND OF THE INVENTION

The present invention relates to a thermoplastic resin composition, and more particularly, it relates to a thermoplastic resin composition containing a copolyester resin and a polycarbonate resin, and exhibiting a high transparency and a good chemical resistance and a good hydrolysis resistance. The present invention also relates to a process for producing the said resin composition and a molded product using thereof.

Thermoplastic resins, especially engineering plastics, are used for a variety of purposes because of their excellent mechanical strength and impact resistance. These resins, however, have their own problems. For example, polyester resins, although excellent in chemical resistance, etc., are not necessarily satisfactory in high transparency and good hydrolysis resistance, while polycarbonate resins, though possessed of high transparency and good hydrolysis resistance, are poor in chemical resistance, and thus for such reasons, these thermoplastic resins have been limited in their scope of use.

Hitherto, various proposals involving blending of various types of resins have been made for the improvement of chemical resistance of polycarbonate resins. For instance, Japanese Patent Publication (KOKOKU) No. 36-14035 discloses a thermoplastic material produced by melting and mixing polyethylene terephthalate and a polycarbonate, and Japanese Patent Application Laid-Open (KOKAI) No. 48-96646 discloses a polycarbonate composition containing polytetramethylene naphthalate and/or polyhexamethylene naphthalate, but these products have the disadvantage of being low in transparency.

A resin composition comprising a polycarbonate and polytetramethylene terephthalate is disclosed in Japanese Patent Application Laid-Open (KOKAI) No. 48-54160, but this composition has the problem that its transparency is impaired, though improved in chemical resistance, when the content of polytetramethylene terephthalate is increased. It is thus difficult with this Laid-Open (KOKAI) to obtain a thermoplastic resin composition which is transparent and also excels in chemical resistance.

### SUMMARY OF THE INVENTION

As a present inventors, earnest study'to solve the above problem, it has been found that the resin composition containing a Lewis acid compound and/or a basic compound and a polycarbonate/copolyester resin in a specific amount exhibits a high transparency and having a good chemical resistance and a good hydrolysis resistance.

The present invention has been attained on the basis of the above finding.

An object of the present invention is to provide a resin composition mainly comprising a copolyester resin and a polycarbonate resin, which exhibits a high transparency and have a good chemical resistance and a good hydrolysis resistance.

To attain the above aim, in the first aspect of the present invention, there is provided a thermoplastic resin composition comprising:

(A) 100 parts by weight of a copolyester resin,

(B) 0.001 to 1 part by weight of a Lewis acid compound, a basic compound or mixture thereof, and

(C) 200 to 1,000,000 parts by weight of a polycarbonate resin,

the morphology of said thermoplastic resin composition comprising a continuous phase and a discontinuous phase dispersed in said continuous phase, and

said discontinuous phase having a size of 1 to 500 nm, when observed by transmission electron microscope.

In the second aspect of the present invention, there is provided a process for producing a thermoplastic resin composition, comprising:

melt-kneading a mixture of 100 parts by weight of a copolyester resin (A) and 0.001 to 1 part by weight of a Lewis acid compound, a basic compound or mixture thereof (B);

adding 200 to 1,000,000 parts by weight of a polycarbonate resin (C) to said copolyester resin composition; and

melt-kneading the mixture of components (A), (B) and (C) to produce a copolyester/polycarbonate resin composition.

The third aspect of the present invention, there is provided a molded product produced from the thermoplastic resin composition as defined in the above first aspect.

### DETAILED DESCRIPTION

The present invention will be explained in detail below.

First, the copolyester resins usable as component (A) in the present invention are explained. In the present invention, there is used a copolyester resin comprising at least two kinds of dicarboxylic acid moieties and at least one kind of diol moiety, in which 1 to 50 mol % of the whole dicarboxylic acid moieties is a naphthalenedicarboxylic acid moiety. A method for obtaining such a copolyester resin comprises copolymerizing a naphthalenedicarboxylic acid and a dicarboxylic acid other than naphthalenedicarboxylic acid with a diol. In place of the naphthalenedicarboxylic acid and/or the said other dicarboxylic acid, ester-forming derivatives of thereof may be used.

As the naphthalenedicarboxylic acid, isomers of various naphthalenedicarboxylic acids such as 2,6-naphthalenedicarboxylic acid, 2,7-naphthalenedicarboxylic acid, 2,3-naphthalenedicarboxylic acid, 1,8-naphthalenedicarboxylic acid, 1,7-naphthalenedicarboxylic acid, 1,6-naphthalenedicarboxylic acid, 1,5-naphthalenedicarboxylic acid, 1,4-naphthalenedicarboxylic acid, 1,3-naphthalenedicarboxylic acid and 1,2-naphthalenedicarboxylic acid can be used. These naphthalenedicarboxylic acid isomers may be used as a mixture of two or more of them. Of these naphthalenedicarboxylic acids, 2,6-naphthalenedicarboxylic acid is especially preferred.

As the dicarboxylic acid other than naphthalenedicarboxylic acids, there can be used, for example, aromatic dicarboxylic acids, alicyclic dicarboxylic acids, aliphatic dicarboxylic acids and oxyacids, of which aromatic dicarboxylic acids are preferred. Examples of such aromatic dicarboxylic acids include phthalic acid, isophthalic acid, terephthalic acid, diphenyldicarboxylic acid, diphenoxyethanedicarboxylic acid and diphenyl ether dicarboxylic acid.

The alicyclic dicarboxylic acids include hydrogenation compounds of the said aromatic dicarboxylic acids, such as hexahydroterephthalic acid and hexahydroisophthalic acid. The aliphatic dicarboxylic acids include succinic acid, glutamic acid, adipic acid, suberic acid, azelaic acid, sebacic acid, and dodecanedioic acid. The oxyacids include hydroxybenzoic acid and hydroxycaproic acid. These dicarboxylic acids may be used as a mixture of two or more of them as desired. Of these dicarboxylic acids, phthalic acid, isophthalic acid and terephthalic acid are preferred, terephthalic acid being especially preferred.

The diols usable in the present invention include aliphatic diols, alicyclic diols, aromatic diols and ethylene oxide adducts of aromatic diols. Aliphatic diols are preferred. Examples of such aliphatic diols include ethylene glycol, 1,2-propanediol, 1,3-propanediol, 1,4-butanediol, 1,5-pentanediol, 1,6-hexanediol, 1,2-decanediol, 1,10-decanediol, neopentyl glycol; and polyalkylene glycols such as diethylene glycol, triethylene glycol, polyethylene glycol, polypropylene glycol and polytetramethylene glycol.

Examples of the alicyclic diols include 1,2-cyclohexanediol, 1,4-cyclohexanediol, 1,1-cyclohexanedimethanol, 1,4-cyclohexanedimethanol and the like. Examples of the aromatic diols include 2,2-bis(4-hydroxyphenyl)propane, bis(4-hydroxyphenyl)methane, 1,1-bis(4-hydroxyphenyl)ethane, 2,2-bis(4-hydroxy-3-methylphenyl)propane, 1,1-bis(4-hydroxyphenyl)-1-phenylethane, and 1,1-bis(4-hydroxyphenyl)cyclohexane.

Examples of the ethylene oxide adducts of aromatic diols include 2,2-bis (4-β-hydroxyethoxyphenyl) propane and bis (4-β-hydroxyethoxyphenyl)sulfone. These diols may be used as a mixture of two or more of them. Of these diols, ethylene glycol and 1,4-butanediol are preferred, ethylene glycol being especially preferred.

In the copolyester resin (A), the percentage of naphthalenedicarboxylic acid in the dicarboxylic acid moieties is 1 to 50 mol %. If this percentage is less than 1 mol %, the effect of improving chemical resistance is unsatisfactory. If the percentage exceeds 50 mol %, the composition deteriorates in transparency. The lower limit of the percentage of naphthalenedicarboxylic acid in the dicarboxylic acid moiety is preferably not less than 2 mol %, more preferably not less than 4 mol %, even more preferably not less than 6 mol %. The upper limit of the percentage of naphthalenedicarboxylic acid in the dicarboxylic acid moieties is preferably not more than 40 mol %, more preferably not more than 25 mol %.

Molecular weight of the copolyester resin (A) is not specifically defined in the present invention, but when it is expressed in terms of intrinsic viscosity measured in a 5/5 wt ratio mixed solvent of tetrachloroethane and phenol at 30° C., it is usually 0.3 to 2.0 dl/g, preferably 0.4 to 1.5 dl/g, more preferably 0.5 to 1.4 dl/g.

Second, the Lewis acid compound and/or the basic compound (B) used in the present invention are explained. Examples of the Lewis acid compound and/or the basic compound (B) used in the present invention may include aliphatic carboxylic acid salts such as sodium montanate, lithium montanate, calcium montanate, sodium stearate, lithium stearate, potassium stearate, calcium stearate, magnesium stearate, sodium acetate, calcium acetate and magnesium acetate. Among these compounds, alkali metal salts and alkali earth metal salts are preferred. In addition, as the Lewis acid compound and/or the basic compound, there may also be used tin compounds such as dibutyl tin oxide, tin oxalate, tin acetate, tin oxide, dibutyl tin dimethoxide and butyl tin hydroxide oxide; titanium compounds such as tetrabutoxy titanium, tetraphenoxy titanium, titanium oxide and titanium oxalate; antimony compounds such as antimony trioxide and antimony oxide tartrate; zinc compounds such as zinc acetate, zinc stearate and zinc acetyl acetone; boric acid compounds such as triphenoxy boron and zinc borate; germanium compounds such as germanium oxide and germanium ethoxide; manganese acetate; and cobalt acetate, as well as metal compounds such as hydroxides of alkali metals, e.g., sodium, potassium, lithium, cesium or the like, or hydroxides of alkali earth metals, e.g., calcium, magnesium, barium or the like. These Lewis acid compounds and basic compounds may be used alone or in the form of a mixture of any two or more thereof. Among these Lewis acid compounds and basic compounds, aliphatic carboxylic acid salts, especially alkali metal salts and alkali earth metal salts, titanium compounds, tin compounds and alkali metal hydroxides are preferred; alkali metal stearates, alkali metal stearates, alkali metal montanates, alkali earth metal montanates, tetrabutoxy titanium, dibutyl tin oxide and sodium hydroxide are more preferred; and alkali metal stearates and alkali earth metal stearates are especially preferred.

The Lewis acid compound and/or the basic compound (B) may be used in an amount of 0.001 to 1 part by weight based on 100 parts by weight of the copolyester resin (A). When the amount of the Lewis acid compound and/or the basic compound (B) is less than 0.001 part by weight, the copolyester resin (A) cannot be sufficiently compatible with the polycarbonate resin (C) upon kneading the copolyester resin composition composed of the copolyester resin (A) and the Lewis acid compound and/or the basic compound (B) with the polycarbonate resin (C), resulting in deteriorated transparency of the obtained composition. On the contrary, when the amount of the Lewis acid compound and/or the basic compound (B) is more than 1 part by weight, the polycarbonate resin (C) undergoes remarkable decomposition upon kneading the copolyester resin composition with the polycarbonate resin (C). The amount of the Lewis acid compound and/or basic compound (B) used is preferably 0.005 to 0.5 part by weight, more preferably 0.01 to 0.3 part by weight based on 100 parts by weight of the copolyester resin (A).

As the polycarbonate resins usable as (C), aromatic polycarbonates are preferred. As the process for producing the polycarbonate resins, various methods such as phosgene process and esterexchange process can be used. The polycarbonate resins usable as (C) include polymers or copolymers of the thermoplastic aromatic polycarbonates obtained by reacting aromatic dihydroxyl compounds or these compounds plus a small quantity of polyhydroxyl compounds with phosgene or a carbonic acid diester. Such polycarbonates may be branched.

Examples of the aromatic dihydroxyl compounds usable for the above reaction include bis(hydroxyaryl)alkanes such as 2,2-bis(4-hydroxyphenyl)propane (bisphenol A); 2,2-bis(3,5-dibromo-4-hydroxyphenyl)propane (tetrabromobisphenol A), bis (4-hydroxyphenyl)methane, 1,1-bis(4-hydroxyphenyl)ethane, 2,2-bis(4-hydroxyphenyl)butane, 2,2-bis(4-hydroxyphenyl)octane, 2,2-bis(4-hydroxy-3-methylphenyl)propane, 1,1-bis(3-t-butyl-4-hydroxyphenyl)propane, 2,2-bis(4-hydroxy-3,5-dimethylphenyl)propane, 2,2-bis(3-bromo-4-hydroxyphenyl)propane, 2,2-bis(3,5-dichloro-4-hydroxyphenyl)propane, 2,2-bis(3-phenyl-4-hydroxyphenyl)propane, 2,2-bis(3-cyclohexyl-4-hydroxyphenyl)propane, 1,1-bis(4-hydroxyphenyl)-1-phenylethane, and bis(4-hydroxyphenyl)diphenylmethane; bis(hydroxyaryl)cycloalkanes such as 1,1-bis(4-hydroxyphenyl)cyclopentane, 1,1-bis(4-hydroxyphenyl)cyclohexane, and 1,1-bis(4-hydroxyphenyl)-3,3,5-trimethylcyclohexane; dihydroxydiaryl ethers such as 4,4′-dihydroxydiphenyl ether and 4,4′-dihydroxy-3,3′-dimethyldiphenyl ether; dihydroxydiaryl sulfides such as 4,4′-dihydroxydiphenyl sulfide and 4,4′-dihydroxy-3,3′-dimethyldiphenyl sulfide; dihydroxydiaryl sulfoxides such as 4,4′-dihydroxydiphenyl sulfoxide and 4,4′-dihydroxy-3,3,-dimethyldiphenyl sulfoxide; dihydroxydiaryl sulfones such as 4,4,-dihydroxydiphenyl sulfone and 4,4,-dihydroxy-3,3,-dimethyldiphenyl sulfone; hydroquinone, resorcin, 4,4′-dihydroxydiphenyl and the like. If necessary these aromatic dihydroxyl compounds may be used as a mixture of two or more of them. Of these compounds, 2,2-bis(4-hydroxyphenyl)propane (bisphenol A) is especially preferred.

For obtaining the branched aromatic polycarbonate resins, polyhydroxyl compounds such as phloroglucin, 2,6-dimethyl-2,4,6-tris(4-hydroxyphenyl)-3-heptene, 4,6-dimethyl-2,4,6-tris(4-hydroxyphenyl)-2-heptene, 1,3,5-tris(2-hydroxyphenyl)benzole, 1,1,1-tris(4-hydroxyphenyl)ethane, 2,6-bis (2-hydroxy-5-methylbenzyl)-4-methylphenol, and α,α′,α″-tris(4-hydroxyphenyl)-1,3,5-triisopropylbenzene; 3,3-bis(4-hydroxyaryl)oxyindole (isatinbisphenol), 5-chloroisatinbisphenol, 5,7-dichloroisatinbisphenol, 5-bromoisatinbisphenol and the like, may be used.

In the case of phosgene process polycarbonates, a terminator or a molecular weight modifier may be used. As such a terminator or molecular weight modifier, there can be used the compounds having monovalent phenolic hydroxyl groups, which include, beside ordinary phenols such as p-t-butylphenol and tribromophenol, long-chain alkylphenols, aliphatic carboxylic acid chloride, aliphatic carboxylic acids, aromatic carboxylic acids, hydroxybenzoic acid alkyl esters, alkyl ether phenols and the like. In the case of the polycarbonate resins used in the present invention, these terminators or molecular weight modifiers may be used if necessary as a mixture of two or more of them.

Molecular weight of polycarbonate resins (C) of the present invention, determined as viscosity-average molecular weight converted from the solution viscosity measured in methylene chloride at 25° C., is usually 10,000 to 100,000, preferably 15,000 to 50,000.

In the thermoplastic resin composition of the present invention, the amount of the polycarbonate resin (C) used therein is 200 to 1,000,000 parts by weight based on 100 parts by weight of the copolyester resin (A). When the amount of the polycarbonate resin (C) used is less than 200 parts by weight, the obtained composition is insufficient in transparency. On the contrary, when the amount of the polycarbonate resin (C) used is more than 1,000,000 parts by weight, the obtained composition cannot be sufficiently improved in chemical resistance. The amount of the polycarbonate resin (C) used is preferably 1,000 to 100,000 parts by weight, more preferably 2,000 to 50,000 parts by weight based on 100 parts by weight of the copolyester resin (A).

The thermoplastic resin composition of the present invention may further contain an organophosphorus compound (D). The amount of the organophosphorus compound (D) used in the composition is 0.0001 to 1 part by weight based on 100 parts by weight of sum of the components (A), (B) and (C).

Examples of the organophosphorus compounds (D) may include organic phosphate compounds, organic phosphite compounds or organic phosphonite compounds. As the preferred organic phosphate compounds, there may be exemplified long-chain dialkyl acid phosphate compounds represented by the following general formula (I):

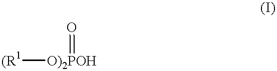

wherein R¹ is C₈ to C₃₀ alkyl.

Specific examples of the C₅ to C₃₀ alkyl groups may include octyl, 2-ethylhexyl, isooctyl, nonyl, isononyl, decyl, isodecyl, dodecyl, tridecyl, isotridecyl, tetradecyl, hexadecyl, octadecyl, eicosyl, triaconttyl or the like.

As the preferred organic phosphite compounds, there may be exemplified those compounds represented by the following general formula (II):

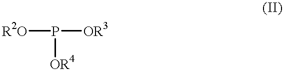

wherein R², R³ and R⁴ are independently a hydrogen atom, a C₁ to C₃₀ aliphatic group or a C₆ to C₃₀ aromatic group, with the proviso that at least one of R², R³ and R⁴ is the C₆ to C₃₀ aromatic group.

Specific examples of the organic phosphite compounds may include tris(2,4-di-tert-butylphenyl)phosphite, bis(2,4-di-tert-butylphenyl)pentaerythritol-di-phosphite, bis(2,6-di-tert-butyl-4-methylphenyl)pentaerythritol-di-phosphite, 2,2-methylene-bis(4,6-di-tert-butylphenyl)octyl phosphite, 4,41-butylidene-bis(3-methyl-6-tert-butylphenyl-di-tridecyl) phosphite, 1,1,3-tris(2-methyl-4-di-tridecylphosphite-5-tert-butylphenyl)butane, tris(mixed mono- and di-nonylphenyl)phosphite, tris(nonylphenyl)phosphite, 4,4′-isopropylidene-bis(phenyl-dialkyl phosphite) or the like. Among these compounds, tris(2,4-di-tert-butylphenyl)phosphite, 2,2-methylene-bis(4,6-di-tert-butylphenyl)octyl phosphite and bis(2,6-di-tert-butyl-4-methylphenyl) pentaerythritol-di-phosphite are preferred.

As the preferred organic phosphonite compounds, there may be exemplified those compounds represented by the following general formula (III):

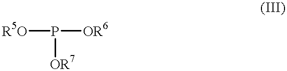

wherein R⁵, R⁶ and R⁷ are independently a hydrogen atom, a C₁ to C₃₀ aliphatic group or a C₆ to C₃₀ aromatic group, with the proviso that at least one of R⁵, R⁶ and R⁷ is the C₆ to C₃₀ aromatic group.

Specific examples of the organic phosphonite compounds may include tetrakis(2,4-di-tert-butylphenyl)-4,4′-biphenylene phosphonite or the like.

Among these organophosphorus compounds (D), the organic phosphate compounds are preferred.

The amount of the organophosphorus compound (D) used is 0.0001 to 1 part by weight based on 100 parts by weight of sum of the copolyester resin (A), the Lewis acid compound and/or the basic compound (B) and the polycarbonate resin (c). When the amount of the organophosphorus compound (D) used is less than 0.0001 part by weight, the obtained composition may be deteriorated in heat stability as well as retention stability in molding apparatus. On the contrary, when the amount of the organophosphorus compound (D) used is more than 1 part by weight, other properties of the obtained composition tend to be adversely affected. The amount of the organophosphorus compound (D) used is preferably 0.001 to 0.5 part by weight, more preferably 0.005 to 0.3 part by weight based on 100 parts by weight of sum of the components (A) to (C). Also, these organophosphorus compounds (D) may be used alone or in the form of a mixture of any two or more thereof. Thus, when the organophosphorus compound (D) is added, the obtained composition can be improved in heat stability and retention stability in molding apparatus.

In accordance with the present invention, the copolyester/polycarbonate resin composition is required to have a morphology of a dispersion phase comprising a continuous phase and a discontinuous phase dispersed in the continuous phase when observed by transmission electron microscope. Preferably, the continuous phase mainly comprises the polycarbonate resin (C), and the discontinuous phase mainly composes the copolyester resin (A). Here, the dispersion phase means such a phase constituted by two phases, i.e., continuous and discontinuous phases, when observed by transmission electron microscope. In the present invention, it is considered that the discontinuous phase comprising the copolyester resin (A) contributes to improvement in chemical resistance of the obtained composition. In the thermoplastic resin composition of the present invention, the discontinuous phase has a size of 1 to 500 nm when measured by the following method. That is, a central portion of a 3 mm-thick specimen molded from the composition is stained with ruthenium oxide (RuO₄), and then the ultra-thin film of stained specimen is observed and photographed at a magnification of 15,000 times by the transmission electron microscope to measure a size of the discontinuous phase on microphotograph. In the present invention, the “size of the discontinuous phase” means a longitudinal diameter of discontinuous phase, and substantially the longitudinal diameter of all discontinuous phase, concretely the longitudinal diameter of not less than 90% of discontinuous phase is within the range of 1 to 500 nm. The discontinuous phase of the composition preferably has a size not more than the wavelength of visible rays, specifically in the range of 10 to 400 nm. When the size of the discontinuous phase is less than 1 nm, the obtained composition is deteriorated in chemical resistance. On the contrary, when the size of the discontinuous phase is more than 500 nm, the obtained composition is deteriorated in transparency.

The thermoplastic resin composition of the present invention may contain, depending on the purpose of its use, for affording the desired extra properties, other polymers, flame-retardant, impact modifier, antioxidant, thermal stabilizer, UV absorber, antistatic agent, plasticizer, release agent, lubricant, compatibilizing agent, foaming agent, one or more of other reinforcing agents or fillers such as glass fiber, glass beads, glass flakes, carbon fiber, fibrous magnesium, potassium titanate whisker, ceramic whisker, mica, talc, colorants and etc.

The thermoplastic resin composition of the present invention may be produced, for example, by the following methods. First, a copolyester resin composition is prepared by adding the Lewis acid compound and/or the basic compound (B) to the copolyester resin (A) and melt-kneading the resultant mixture, or by producing the copolyester resin (A) while adding the Lewis acid compound and/or the basic compound (B) thereto. Then, the polycarbonate resin (C) is added to the thus obtained copolyester resin composition, and the resultant mixture is melt-kneaded to produce the thermoplastic resin composition. Among the above methods, the former method in which the copolyester resin composition is prepared by adding the Lewis acid compound and/or the basic compound (B) to the copolyester resin (A) and melt-kneading the resultant mixture, is preferred. The thermoplastic resin composition obtained by this method is prevented from undergoing undesired decomposition and, therefore, is free from deterioration in properties thereof.

More concreately, there is exemplified a method comprising melt-kneading 100 parts by weight of a copolyester resin (A) and 0.001 to 1 part by weight of a Lewis acid compound, a basic compound or mixture thereof (B) to obtain a copolyester resin composition; adding 200 to 1,000,000 parts by weight of a polycarbonate resin (C) to said copolyester resin composition; and melt-kneading the resultant mixture of components (A), (B) and (C) to produce a copolyester/polycarbonate resin composition. In the present invention, as shown the above process, the step of melt-kneading the copolyester resin (A) and the Lewis acid compound, a basic compound or mixture thereof (B) to obtain a copolyester resin composition; and the step of adding the polycarbonate resin (C) and melt-kneading the mixture can be conducted separately. But a method in which the copolyester resin (A) and the Lewis acid compound and/or a basic (B) are melt-kneaded in the initial melt-kneading stage in the same melt-kneading machine, and when the melt-kneading is mostly conducted, the polycarbonate resin (C) is added and melt-kneaded continuously.

Further, in the case where the organophosphorus compound (D) is incorporated, the thermoplastic resin composition of the present invention is preferably produced by the following method. The copolyester resin composition containing the copolyester resin (A) and the Lewis acid compound and/or the basic compound (B) is melt-kneaded with the polycarbonate resin (C) as described above, and then the organophosphorus compound (D) is added to the thus obtained resin composition. The addition of the organophosphorus compound (D) can provide such an effect that the obtained thermoplastic resin composition is improved in heat stability as well as retention stability in molding apparatus.

As to the addition of the organophosphorus compound (D), the step of melt-kneading the copolyester resin composition and the polycarbonate resin (C), and the step of adding the organophosphorus compound (D) and melt-kneading the mixture can be conducted separately. But a method in which the copolyester resin composition and the polycarbonate resin (C), are melt-kneaded, and when the melt-kneading is mostly conducted, the organophosphorus compound (D) is added and melt-kneaded continuously in the same melt-kneading machine (side feed method).

Meanwhile, the thermoplastic resin composition of the present invention may be produced by any other known methods as long as the respective components can be sufficiently blended or kneaded thereby up to an optional stage before molding the composition into final products.

Blending each component can be effected in the various ways, such as using a suitable mixer like tumbler or Henschel mixer, or supplying the determined amounts of resins to the extruder hopper by a feeder and mixing them. Kneading can be accomplished, for example, by a method using a single- or double-screw extruder.

The melt-kneading temperature used for the production of the copolyester resin composition composed of the copolyester resin (A) and the Lewis acid compound and/or the basic compound (B) is not particularly restricted as long as the polyester contained therein can maintain a good heat stability during the melt-kneading. The temperature of the resin composition in a melt-kneading machine is preferably in the range of 250 to 350° C. This temperature of the resin composition can be attained by usually controlling the barrel temperature to 250 to 300° C. in case of using a double-screw extruder having a screw diameter of not more than 100 mm.

The melt-kneading temperature used for melt-kneading the copolyester resin composition with the polycarbonate resin (C) is also not particularly restricted as long as the polyester resin and the polycarbonate resin can maintain a good heat stability during the melt-kneading, and the temperature of resin composition is usually in the range of 150 to 400° C. This temperature of the resin composition can be attained by usually controlling the barrel temperature to 150 to 350° C. in case of using a double-screw extruder having a screw diameter of not more than 100 mm.

In the present invention, when the copolyester resin composition is melt-kneaded with the polycarbonate resin, it is preferred to remove moisture, gasses or the like therefrom. The removal of moisture, gasses or the like may be simply conducted, for example, using a vented kneader which may be provided with two or more vent devices. Thus, moisture, gasses, etc. may be forcibly removed from the composition under reduced pressure using such vent devices, or may be discharged outside by conducting the melt-kneading in an open system. As apparent from below-described Examples, the removal of moisture, gasses or the like is effective to reduce the change of a flow value of the obtained resin composition (finish flow value) in comparison with the flow value of the polycarbonate resin as a raw material and provide a molded product which is excellent in transparency, hue and the like after being subjected to a pressure cooker test.

The thermoplastic resin composition of the present invention can be molded into desired pieces by the conventionally used molding methods such as injection molding and blow molding. The barrel temperature of the composition according to the present invention is not particularly restricted as long as the copolyester/polycarbonate resin composition can maintain a good heat stability during the molding, and is preferably in the range of 250 to 350° C. in a case of using, for example, an injection molding machine. The molded pieces obtained from the thermoplastic resin composition of the present invention can be applied to a variety of commercial products, such as sheets, films, miscellaneous goods, parts of household electric appliances, automobile parts, building materials, hollow containers, etc., more specifically, roof panels for arcades, carports, indoor swimming pools, etc., light-transmitting molded articles such as sign boards, switch buttons, indicator buttons, indicator panels, meter panels, etc., delineators, signal lamps, sound insulating walls, automobile pasrts such as door window, rear quarter window, sunroof, rear panel garnish, headlight lens, tail lamp, etc., railroad light covers, camera lens, telephone jack, relay cover, terminal block cover, solar battery housing, water tank of iron, control box, pachinko ball case, ornamental jigs, ski goggles, protective spectacles, protective masks, artificial dialyzer, artificial lung case and its cap and connector, mineral water bottle, street lamp cover, etc.

Haze of the molded pieces obtained from the thermoplastic resin composition of the present invention, as determined with a 3 mm thick test piece, is ordinarily not more than 10%, preferably not more than 5%, more preferably not more than 3%.

In the molded product obtained from the copolyester/polycarbonate resin composition according to the present invention, the discontinuous phase thereof has a size of 1 to 500 nm after subjecting the molded product to a pressure cooker test in which the molded product is treated at a temperature of 121° C. and a humidity of 100% under a pressure of 0.20 MPa for 8 hours. The above size of the discontinuous phase is substantially identical to the wavelength range of visible rays. When the size of the discontinuous phase lies within the wavelength range of visible rays, the obtained composition can exhibit an very high transparency. The size of the discontinuous phase is preferably in the range of 10 to 400 nm. Also, the haze of the molded product according to the present invention is preferably not more than 5%, more preferably not more than 3% when measured as to a 3 mm-thick specimen thereof. When the haze is more than 5%, the molded product is deteriorated in transparency. As to the hue of the molded product according to the present invention, the YI value thereof is preferably not more than 7, more preferably not more than 5. When the YI value is more than 7, the molded product is deteriorated in hue.

The thermoplastic resin composition of the present invention is excellent not only in transparency, but also in various other properties such as chemical resistance and especially hydrolysis resistance. Thus, the thermoplastic resin composition of the present invention is extremely useful in various applications in which the above properties are required.

### EXAMPLES

The present invention will be described in more detail below by reference to the following examples. However, these examples are only illustrative and not intended to limit the present invention thereto.

Meanwhile, raw materials and evaluation methods used in the following Examples and Comparative Examples are as follows.

<Polyester Resin (for Examples)>

(A1) Copolyester resin: “NOVAPEX NC102Z” produced by Mitsubishi Chemical Corporation; copolymerized polyethylene terephthalate resin containing 8% naphthalene dicarboxylic acid; intrinsic viscosity: 0.81.

<Polyester Resins (for Comparative Examples)>

(A2) Polyethylene terephthalate resin: “RT580CA” produced by Mitsubishi Chemical Corporation; intrinsic viscosity: 1.20; and

(A3) Polyethylene naphthalate resin: “NOVAPEX FS405Z” produced by Mitsubishi Chemical Corporation; intrinsic viscosity: 0.70.

<Lewis Acid Compound and/or Basic Compound (B)>

(B1) Sodium stearate produced by Nihon Yushi Co., Ltd.;

(B2) Lithium stearate produced by Tokyo Kasei Co., Ltd.;

(B3) Potassium stearate produced by Kanto Kagaku Co., Ltd.;

(B4) Sodium montanate produced by Clariant Japan Co., Ltd.;

(B5) Tetrabutoxy titanium produced by Mitsubishi Gas Chemical Co., Ltd.;

(B6) Dibutyl tin oxide produced by Tokyo Kasei Co., Ltd.;

(B7) Sodium hydroxide produced by Wako Junyaku Kogyo Co., Ltd.;

(B8) Magnesium stearate produced by Wako Junyaku Kogyo Co., Ltd.; and

(B9) Calcium stearate produced by Wako Junyaku Kogyo Co., Ltd.

<Polycarbonate Resin>

(C1) Polycarbonate resin: “IUPILON S-2000” produced by Mitsubishi Engineering-Plastics Corporation (viscosity-average molecular weight: 25,000).

<Organophosphorus Compound>

(D1) Alkyl acid phosphate: “MARK AX71” produced by Asahi Denka Co., Ltd.; structural formula: (C₃₇H₇₅O)ₙPO(OH)₃₋ₙ.

<Evaluation Methods>

(1) Transparency:

A 3 mm-thick test specimen was measured using “NDH-2000” manufactured by Nihon Denshoku Kogyo Co., Ltd. to determine the haze thereof.

(2) Hue (YI value):

A 3 mm-thick test specimen was measured using “SE-2000” manufactured by Nihon Denshoku Kogyo Co., Ltd. to determine the YI value thereof.

(3) Size of Discontinuous Chase:

A central portion of a 3 mm-thick specimen molded from the composition is stained with ruthenium oxide (RuO₄), and then the ultra-thin film of stained specimen is observed and photographed at a magnification of 15,000 times by the transmission electron microscope “JEM-1200ExII” manufactured by Nihon Denshi Co., Ltd. to measure a size of the discontinuous phase on microphotograph.

(4) Pressure Cooker Test (PCT):

The molded test specimen was treated at a temperature of 121° C. and a humidity of 100% under a pressure of 0.20 MPa for 8 hours using “PC-422R5E” manufactured by Hirayama Seisakusho Co., Ltd.

(5) Chemical Resistance:

A 3.2 mm-thick tensile test specimen was loaded and deflected at a deformation percentage of 1%. While maintaining in this deflected state, the specimen was treated with a test chemical for 48 hours. Then, the thus treated specimen was visually observed to evaluate the chemical resistance thereof. The results were classified into the following evaluation ratings.

(A): No change occurred; and

(B): Crazes generated

Test chemical used: DOP: dioctyl phthalate (di(2-ethylhexy)phthalate produced by Tokyo Kasei Kogyo Co., Ltd.

(6) Flow Value:

Pellets dried at 120° C. for 5 hours or more were subjected to a flow test to measure a volume thereof flowed per unit time at a temperature of 280° C. using a flow tester manufactured by Shimadzu Corporation.

(7) Tensile Strength:

A 3.2 mm-thick specimen was subjected to tensile test by setting a distance between chucks to 110 mm and a pulling speed to 20 mm/minute using “STROGRAPH” manufactured by Toyo Seiki Co., Ltd.

### Examples 1 to 5

A copolyester resin (A) and a Lewis acid compound and/or a basic compound (B) were mixed together at a mixing ratio shown in Table 1 using a tumbler. The obtained mixture was charged into a vented double-screw extruder having a diameter of 30 mm, and extruded therefrom at a barrel temperature of 280° C. to obtain master pellets (precompound). Then, the thus obtained master pellets were mixed with a polycarbonate resin (C1: flow value: 5.2×10⁻² cc/sec.) at a mixing ratio shown in Table 1 using a tumbler. The resultant mixture was charged into a double-screw vent type extruder having a diameter of 30 mm, and extruded therefrom at a barrel temperature of 260° C. while controlling the vacuum of a vent disposed at a die side of the extruder to 40 Torr, thereby obtaining pellets (compound). The thus obtained pellets were dried at 120° C. for not less than 5 hours in a hot air drier, and then injection-molded at a barrel temperature of 280° C. and a mold temperature of 80° C. to obtain a test specimen. The thus obtained test specimen was measured to evaluate physical properties thereof. The results are shown in Table 2.

### Examples 6-8

The same procedure as defined in each of Examples 1 to 5 was conducted except that the Lewis acid compound and/or the basic compound (B) was varied as shown in Table 1, thereby obtaining a molded product and evaluating the properties thereof. The results are shown in Table 2.

### Example 9

A copolyester resin (A) and a Lewis acid compound and/or a basic compound (B) were mixed together at a mixing ratio shown in Table 1 using a tumbler. The resultant mixture was charged into a double-screw vent type extruder having a diameter of 30 mm, and extruded therefrom at a barrel temperature of 280° C. to obtain master pellets (precompound). Then, the thus obtained master pellets were mixed with a polycarbonate resin (C1: flow value: 5.2×10⁻² cc/sec.) at a mixing ratio shown in Table 1 using a tumbler. The resultant mixture was charged into a double-screw vent type extruder having a diameter of 57 mm, and extruded therefrom at a barrel temperature of 300° C. while controlling the vacuum of a vent disposed at a die side of the extruder to 30 Torr, thereby obtaining pellets (compound). The thus obtained pellets were dried at 120° C. for not less than 5 hours in a hot air drier, and then injection-molded at a barrel temperature of 280° C. and a mold temperature of 80° C. to obtain a test specimen. The thus obtained test specimen was measured to evaluate physical properties thereof. The results are shown in Table 2.

### Example 10

A copolyester resin (A) and a Lewis acid compound and/or a basic compound (B) were mixed together at a mixing ratio shown in Table 1 using a tumbler. The resultant mixture was charged into a double-screw vent type extruder having a diameter of 30 mm, and extruded therefrom at a barrel temperature of 280° C. to obtain master pellets (precompound). Then, the thus obtained master pellets were mixed with a polycarbonate resin (C1: flow value: 5.2×10⁻² cc/sec.) at a mixing ratio shown in Table 1 using a tumbler. The resultant mixture was charged into a double-screw vent type extruder having a diameter of 57 mm from a main feeder thereof. Further, an organophosphorus compound (D1) was charged into the double-screw vented extruder having a diameter of 57 mm through a side feeder thereof in such an amount as shown in Table 1 in the form of a mixture with a small amount of the polycarbonate resin. The resultant mixture was extruded from the extruder at a barrel temperature of 300° C. while controlling the vacuum of a vent disposed at a die side of the extruder to 30 Torr, thereby obtaining pellets (compound). The thus obtained pellets were dried at 120° C. for not less than 5 hours in a hot air drier, and then injection-molded at a barrel temperature of 280° C. and a mold temperature of 80° C. to obtain a test specimen. The thus obtained test specimen was measured to evaluate physical properties thereof. The results are shown in Table 2.

### Examples 11 to 14

The same procedure as defined in Example 10 was conducted except that vented conditions of the extruder used upon compounding were changed to those as shown in Table 1, thereby obtaining a molded product and evaluating properties thereof. The results are shown in Table 2.

### Examples 15 and 16

The same procedure as defined in Example 13 was conducted except that the Lewis acid compound and/or the basic compound (B) was changed to those as shown in Table 1, thereby obtaining a molded product and evaluating properties thereof. The results are shown in Table 2.

### Examples 17 and 18

A copolyester resin (A) and a Lewis acid compound and/or a basic compound (B) were mixed together at a mixing ratio shown in Table 1 using a tumbler. The obtained mixture was charged into a double-screw vent type extruder having a diameter of 30 mm, and extruded therefrom at a barrel temperature of 280° C. to obtain master pellets (precompound). Then, the thus obtained master pellets were mixed with a polycarbonate resin (C1: flow value: 5.2×10⁻² cc/sec.) at a mixing ratio shown in Table 1 using a tumbler. The resultant mixture was charged into a double-screw vent type extruder having a diameter of 30 mm, and extruded therefrom at a barrel temperature of 260° C. while controlling the vacuum of a vent disposed at a die side of the extruder to 40 Torr, thereby obtaining pellets. The thus obtained pellets were mixed with an organophosphorus compound (D1) at a mixing ratio shown in Table 1 using a tumbler. The resultant mixture was charged into a double-screw vent type extruder having a diameter of 30 mm, and extruded therefrom at a barrel temperature of 260° C. while controlling the vacuum of the vent disposed at a die side of the extruder to 40 Torr, thereby obtaining pellets (compound). The thus obtained pellets were dried at 120° C. for not less than 5 hours in a hot air drier, and then injection-molded at a barrel temperature of 280° C. and a mold temperature of 80° C. to obtain a test specimen. The thus obtained test specimen was measured to evaluate physical properties thereof. The results are shown in Table 2.

In the above Examples, it was confirmed that even when the pellets were retained in an injection-molding machine at 280° C. for 20 minutes, the obtained molded product was free from generation of silvers and prevented from being increased in YI value.

### Comparative Example 1

A polycarbonate resin (C1) was dried at 120° C. for not less than 5 hours, and then injection-molded by the same method as defined in Example 1. The obtained molded product was measured to evaluate properties thereof. The results are shown in Table 2.

### Comparative Example 2

PET (A2) and a polycarbonate resin (C1) were mixed together at a mixing ratio shown in Table 1 using a tumbler. The resultant mixture was charged into a double-screw vent type extruder having a diameter of 30 mm, and extruded therefrom at a barrel temperature of 260° C. by controlling the vacuum of a vent provided at a die side of the extruder to 40 Torr, thereby obtaining pellets. The thus obtained pellets were dried at 120° C. for not less than 5 hours in a hot air drier, and then injection-molded at a barrel temperature of 280° C. and a mold temperature of 80° C. to obtain a test specimen. The thus obtained test specimen was measured to evaluate properties thereof. The results are shown in Table 2.

### Comparative Example 3

PEN (A3) and a polycarbonate resin (C1) were mixed together at a mixing ratio shown in Table 1 using a tumbler. The resultant mixture was charged into a double-screw vent type extruder having a diameter of 30 mm, and extruded therefrom at a barrel temperature of 280° C. by controlling the vacuum of a vent provided at a die side of the extruder to 40 Torr, thereby obtaining pellets. The thus obtained pellets were dried at 120° C. for not less than 5 hours in a hot air dryier, and then injection-molded at a barrel temperature of 280° C. and a mold temperature of 80° C. to obtain a test specimen. The thus obtained test specimen was measured to evaluate properties thereof. The results are shown in Table 2.

### Comparative Example 4

PET (A2) and a Lewis acid salt (B1) were mixed together at a mixing ratio shown in Table 1 using a tumbler. The resultant mixture was charged into a double-screw vent type extruder having a diameter of 30 mm, and extruded therefrom at a barrel temperature of 280° C. to obtain master pellets (precompound). Then, the thus obtained master pellets were mixed with a polycarbonate resin at a mixing ratio shown in Table 1 using a tumbler. The resultant mixture was charged into a double-screw vent type extruder having a diameter of 30 mm, and extruded therefrom at a barrel temperature of 260° C. by controlling the vacuum of a vent provided at a die side of the extruder to 40 Torr, thereby obtaining pellets (compound). The thus obtained pellets were dried at 120° C. for not less than 5 hours in a hot air drier, and then injection-molded at a barrel temperature of 280° C. and a mold temperature of 80° C. to obtain a test specimen. The thus obtained test specimen was measured to evaluate properties thereof. The results are shown in Table 2.

### Comparative Example 5

PET (A2), a polycarbonate resin (C1) and a Lewis acid salt (B1) were mixed together at a mixing ratio shown in Table 1 using a tumbler. The resultant mixture was charged into a double-screw vent type extruder having a diameter of 30 mm, and extruded therefrom at a barrel temperature of 260° C. by controlling the vacuum of a vent provided at a die side of the extruder to 40 Torr, thereby obtaining pellets. The thus obtained pellets suffered from decomposition and, therefore, exhibited an extraordinarily high flow value. The pellets were dried at 120° C. for not less than 5 hours in a hot air drier, and then injection-molded at a barrel temperature of 280° C. and a mold temperature of 80° C. to obtain a test specimen. The thus obtained test specimen was measured to evaluate properties thereof. The results are shown in Table 2.

TABLE 1

| | Precompounding | | | |
|---|---|---|---|---|
| | Copolyester (A) | | Lewis acid compound/basic compound (B) | |
| | Kind | Amount (wt. part) | Kind | Amount (wt. part) |
| Ex. 1 | A1 | 100 | B1 | 0.2 |
| Ex. 2 | A1 | 100 | B2 | 0.2 |
| Ex. 3 | A1 | 100 | B3 | 0.2 |
| Ex. 4 | A1 | 100 | B4 | 0.3 |
| Ex. 5 | A1 | 100 | B1 | 0.04 |
| Ex. 6 | A1 | 100 | B5 | 0.4 |
| Ex. 7 | A1 | 100 | B6 | 0.2 |
| Ex. 8 | A1 | 100 | B7 | 0.03 |
| Ex. 9 | A1 | 100 | B1 | 0.2 |
| Ex. 10 | A1 | 100 | B1 | 0.2 |
| Ex. 11 | A1 | 100 | B1 | 0.2 |
| Ex. 12 | A1 | 100 | B1 | 0.2 |
| Ex. 13 | A1 | 100 | B1 | 0.2 |
| Ex. 14 | A1 | 100 | B1 | 0.2 |
| Ex. 15 | A1 | 100 | B8 | 0.2 |
| Ex. 16 | A1 | 100 | B9 | 0.2 |
| Ex. 17 | A1 | 100 | B1 | 0.2 |
| Ex. 18 | A1 | 100 | B2 | 0.2 |
| Comp. | — | — | — | — |
| Ex. 1 | | | | |
| Comp. | — | — | — | — |
| Ex. 2 | | | | |
| Comp. | — | — | — | — |
| Ex. 3 | | | | |
| Comp. | A2 | 100 | B1 | 0.2 |
| Ex. 4 | | | | |
| Comp. | Mixing amount (no precompound) | | | |
| Ex. 5 | A2 | 100 | B1 | 0.2 |

| | | | | | | | Compounding | |
|---|---|---|---|---|---|---|---|---|
| | Compounding | | | | | | (2nd time) | |
| | | | | | Organo- | | Organo- | |
| | | | | | phosphorus | | phosphorus | |
| | Precompound | | PC(C) | | compound (D)*² | | compound (D) | |
| | | Amount | | Amount | | Amount | | Amount |
| | Kind | (wt. part) | Kind | (wt. part) | Kind | (wt. part) | Kind | (wt. part) |
| Ex. 1 | A1 + B1 | 1 | C1 | 99 | — | — | — | — |
| Ex. 2 | A1 + B2 | 1 | C1 | 99 | — | — | — | — |
| Ex. 3 | A1 + B3 | 1 | C1 | 99 | — | — | — | — |
| Ex. 4 | A1 + B4 | 1 | C1 | 99 | — | — | — | — |
| Ex. 5 | A1 + B1 | 5 | C1 | 95 | — | — | — | — |
| Ex. 6 | A1 + B5 | 1 | C1 | 99 | — | — | — | — |
| Ex. 7 | A1 + B6 | 1 | C1 | 99 | — | — | — | — |
| Ex. 8 | A1 + B7 | 1 | C1 | 99 | — | — | — | — |
| Ex. 9 | A1 + B1 | 1 | C1 | 99 | — | — | — | — |
| Ex. 10 | A1 + B1 | 1 | C1 | 99 | D1 | 0.02 | — | — |
| Ex. 11 | A1 + B1 | 1 | C1 | 99 | D1 | 0.02 | — | — |
| Ex. 12 | A1 + B1 | 1 | C1 | 99 | D1 | 0.02 | — | — |
| Ex. 13 | A1 + B1 | 1 | C1 | 99 | D1 | 0.02 | — | — |
| Ex. 14 | A1 + B1 | 1 | C1 | 99 | D1 | 0.02 | — | — |
| Ex. 15 | A1 + B8 | 1 | C1 | 99 | D1 | 0.02 | — | — |
| Ex. 16 | A1 + B9 | 1 | C1 | 99 | D1 | 0.02 | — | — |
| Ex. 17 | A1 + B1 | 1 | C1 | 99 | — | — | D1 | 0.01 |
| Ex. 18 | A1 + B2 | 1 | C1 | 99 | — | — | D1 | 0.01 |
| Comp. | — | — | C1 | 100 | — | — | — | — |
| Ex. 1 | | | | | | | | |
| Comp. | A2*¹ | 1 | C1 | 99 | — | — | — | — |
| Ex. 2 | | | | | | | | |
| Comp. | A3*¹ | 1 | C1 | 99 | — | — | — | — |
| Ex. 3 | | | | | | | | |
| Comp. | A2 + B1 | 1 | C1 | 99 | — | — | — | — |
| Ex. 4 | | | | | | | | |
| Comp. | A2 + B1*¹ | 1 | C1 | 99 | — | — | — | — |
| Ex. 5 | | | | | | | | |

*¹No precompound
*²Side feed

| | Compounding machine | Vented conditions upon compounding | |
|---|---|---|---|
| | Double-screw extruder | Hopper-side vent | Die-side vent |
| | Diameter (mm) | Vacuum (Torr) | Vacuum (Torr) |
| Ex. 1 | 30 | — | 40 |
| Ex. 2 | 30 | — | 40 |
| Ex. 3 | 30 | — | 40 |
| Ex. 4 | 30 | — | 40 |
| Ex. 5 | 30 | — | 40 |
| Ex. 6 | 30 | — | 40 |
| Ex. 7 | 30 | — | 40 |
| Ex. 8 | 30 | — | 40 |
| Ex. 9 | 57 | — | 30 |
| Ex. 10 | 57 | — | 30 |
| Ex. 11 | 57 | 80 | — |
| Ex. 12 | 57 | Open | 30 |
| Ex. 13 | 57 | 80 | 30 |
| Ex. 14 | 57 | — | — |
| Ex. 15 | 57 | 80 | 30 |
| Ex. 16 | 57 | 80 | 30 |
| Ex. 17 | 30 | — | 40 |
| Ex. 18 | 30 | — | 40 |
| Comp. | 30 | — | 40 |
| Ex. 1 | | | |
| Comp. | 30 | — | 40 |
| Ex. 2 | | | |
| Comp. | 30 | — | 40 |
| Ex. 3 | | | |
| Comp. | 30 | — | 40 |
| Ex. 4 | | | |
| Comp. | 30 | — | 40 |
| Ex. 5 | | | |

TABLE 2

| | Initial value | | |
|---|---|---|---|
| | | | Size of discontinuous |
| | Haze (%) | YI | phase (nm) |
| Ex. 1 | 0.3 | 1.7 | 50-300 |
| Ex. 2 | 0.3 | 1.7 | 50-300 |
| Ex. 3 | 0.3 | 2.5 | 50-300 |
| Ex. 4 | 0.3 | 1.9 | 50-300 |
| Ex. 5 | 0.4 | 4.0 | 50-300 |
| Ex. 6 | 0.3 | 3.0 | 50-300 |
| Ex. 7 | 0.3 | 2.2 | 50-300 |
| Ex. 8 | 0.3 | 2.0 | 50-300 |
| Ex. 9 | 0.3 | 2.6 | 50-300 |
| Ex. 10 | 0.3 | 1.6 | 50-300 |
| Ex. 11 | 0.2 | 1.8 | 50-300 |
| Ex. 12 | 0.3 | 1.9 | 50-300 |
| Ex. 13 | 0.2 | 1.8 | 50-300 |
| Ex. 14 | 0.3 | 1.7 | 50-300 |
| Ex. 15 | 0.3 | 1.9 | 50-300 |
| Ex. 16 | 0.3 | 2.1 | 50-300 |
| Ex. 17 | 0.3 | 1.7 | 50-300 |
| Ex. 18 | 0.3 | 1.7 | 50-300 |
| Comp. | 0.3 | 1.5 | — |
| Ex. 1 | | | |
| Comp. | 6.0 | 2.2 | 300-3000 |
| Ex. 2 | | | |
| Comp. | 84.0 | 136.0 | 1000-10000 |
| Ex. 3 | | | |
| Comp. | 0.7 | 3.0 | — |
| Ex. 4 | | | |
| Comp. | 0.5 | 2.2 | — |
| Ex. 5 | | | |
| | After PCT treatment | | |
| | | | Size of discontinuous |
| | Haze (%) | YI | phase (nm) |
| Ex. 1 | 1.0 | 3.3 | 50-300 |
| Ex. 2 | 1.0 | 3.5 | 50-300 |
| Ex. 3 | 1.0 | 4.0 | 50-300 |
| Ex. 4 | 1.5 | 3.8 | 50-300 |
| Ex. 5 | 3.0 | 5.5 | 100-400 |
| Ex. 6 | 2.0 | 5.0 | 50-300 |
| Ex. 7 | 1.5 | 4.0 | 50-300 |
| Ex. 8 | 1.7 | 4.2 | 50-300 |
| Ex. 9 | 2.4 | 3.4 | 50-300 |
| Ex. 10 | 1.5 | 4.1 | 50-300 |
| Ex. 11 | 0.7 | 2.3 | 50-300 |
| Ex. 12 | 0.8 | 3.5 | 50-300 |
| Ex. 13 | 0.8 | 2.5 | 50-300 |
| Ex. 14 | 1.7 | 5.2 | 50-300 |
| Ex. 15 | 0.8 | 2.4 | 50-300 |
| Ex. 16 | 1.0 | 2.8 | 50-300 |
| Ex. 17 | 1.2 | 2.0 | 50-300 |
| Ex. 18 | 1.2 | 2.2 | 50-300 |
| Comp. | 0.6 | 2.1 | — |
| Ex. 1 | | | |
| Comp. | 47.0 | 70.0 | 1000-7000 |
| Ex. 2 | | | |
| Comp. | 85.0 | 138.0 | 1000-10000 |
| Ex. 3 | | | |
| Comp. | 5.5 | 10.0 | — |
| Ex. 4 | | | |
| Comp. | 5.2 | 8.0 | — |
| Ex. 5 | | | |

Tensile strength

| | Chemical | Finish flow | Initial | After PCT |
|---|---|---|---|---|
| | resistance | value | value | treatment |
| | DOP | (10⁻² cc/sec.) | (kgf/cm²) | (kgf/cm²) |
| Ex. 1 | ◯ | 7.8 | 720 | 670 |
| Ex. 2 | ◯ | — | — | — |
| Ex. 3 | ◯ | — | — | — |
| Ex. 4 | ◯ | — | — | — |
| Ex. 5 | ◯ | — | — | — |
| Ex. 6 | ◯ | — | — | — |
| Ex. 7 | ◯ | — | — | — |
| Ex. 8 | ◯ | — | — | — |
| Ex. 9 | ◯ | 10.4 | 720 | 650 |
| Ex. 10 | ◯ | 9.5 | 710 | 670 |
| Ex. 11 | ◯ | 8.6 | 660 | 520 |
| Ex. 12 | ◯ | 8.5 | 730 | 620 |
| Ex. 13 | ◯ | 8.3 | 720 | 650 |
| Ex. 14 | ◯ | 11.1 | 690 | 530 |
| Ex. 15 | ◯ | 6.9 | 690 | 570 |
| Ex. 16 | ◯ | 6.5 | — | — |
| Ex. 17 | ◯ | 6.8 | 730 | 690 |
| Ex. 18 | ◯ | — | — | — |
| Comp. | X | 5.2 | 720 | 520 |
| Ex. 1 | | | | |
| Comp. | — | — | — | — |
| Ex. 2 | | | | |
| Comp. | — | — | — | — |
| Ex. 3 | | | | |
| Comp. | — | — | — | — |
| Ex. 4 | | | | |
| Comp. | — | 33.7 | 560 | 130 |
| Ex. 5 | | | | |

What is claimed is:

1. A thermoplastic resin composition comprising:
(A) 100 parts by weight of a copolyester resin,
(B) 0.001 to 1 part by weight of a Lewis acid compound, a basic compound or mixture thereof, and
(C) 200 to 1,000,000 parts by weight of a polycarbonate resin,
the morphology of said thermoplastic resin composition comprising a continuous phase and a discontinuous phase dispersed in said continuous phase, and
said discontinuous phase having a size of 1 to 500 nm, when observed by transmission electron microscope.

2. The thermoplastic resin composition according to claim 1, wherein the amount of polycarbonate resin (C) is 2,000 to 50,000 parts by weight.

3. The thermoplastic resin composition according to claim 1, wherein the size of said discontinuous phase is 10 to 400 nm.

4. The thermoplastic resin composition according to claim 1, wherein said continuous phase is mainly constituted by the polycarbonate resin (C), and said discontinuous phase is mainly constituted by the copolyester resin (A).

5. The thermoplastic resin composition according to claim 1, wherein said copolyester resin (A) comprises at least two kinds of dicarboxylic acid moieties and at least one kind of diol moiety and said dicarboxylic acid moieties contain a naphthalene dicarboxylic acid moiety in an amount of 1 to 50 mol %.

6. The thermoplastic resin composition according to claim 5, wherein said dicarboxylic acid moieties of the copolyester resin (A) contain a naphthalene dicarboxylic acid moiety and at least one kind of other aromatic dicarboxylic acid moiety.

7. The thermoplastic resin composition according to claim 5, wherein said dicarboxylic acid moieties of the copolyester resin (A) contain a naphthalene dicarboxylic acid moietyt, and at least one kind of dicarboxylic acid moiety selected from the group consisting of terephthalic acid moiety, isophthalic acid moiety and phthalic acid moiety.

8. The thermoplastic resin composition according to claim 5, wherein said diol moiety of the copolyester resin (A) is an aliphatic diol moiety.

9. The thermoplastic resin composition according to claim 5, wherein said diol moiety of the copolyester resin (A) is ethylene glycol moiety or 1,4-butane diol moiety.

10. The thermoplastic resin composition according to claim 1, wherein said Lewis acid compound, basic compound or mixture thereof (B) is an aliphatic carboxylic acid salt.

11. The thermoplastic resin composition according to claim 1, wherein said Lewis acid compound, basic compound or mixture thereof (B) is at least one compound selected from the group consisting of tin compounds, titanium compounds, antimony compounds, zinc compounds, boric acid compounds, germanium compounds, alkali metal compounds and alkali earth metal compounds.

12. The thermoplastic resin composition according to claim 1, wherein said Lewis acid compound, basic compound or mixture thereof (B) is at least one compound selected from the group consisting of alkali metal compounds and alkali earth metal compounds.

13. The thermoplastic resin composition according to claim 1, wherein said Lewis acid compound, basic compound or mixture thereof (B) is at least one compound selected from the group consisting of lithium compounds, sodium compounds, potassium compounds, magnesium compounds and calcium compounds.

14. The thermoplastic resin composition according to claim 1, further comprising an organophosphorus compound (D) in an amount of 0.0001 to 1 part by weight based on 100 parts by weight of sum of said components (A), (B) and (C).

15. The thermoplastic resin composition according to claim 14, wherein said organophosphorus compound (D) is an organic phosphate compound, an organic phosphite compound or an organic phosphonite compound.

16. A process for producing a thermoplastic resin composition, comprising:
melt-kneading a mixture of 100 parts by weight of a copolyester resin (A) and 0.001 to 1 part by weight of a Lewis acid compound, a basic compound or mixture thereof (B) to obtain a copolyester resin composition;
adding 200 to 1,000,000 parts by weight of a polycarbonate resin (C) to said copolyester resin composition; and
melt-kneading the resultant mixture of components (A), (B) and (C) to produce a copolyester/polycarbonate resin composition.

17. A process for producing a thermoplastic resin composition, comprising:
melt-kneading a mixture of 100 parts by weight of a copolyester resin (A), 0.001 to 1 part by weight of a Lewis acid compound, a basic compound or mixture thereof (B) and 200 to 1,000,000 parts by weight of a polycarbonate resin (C) to produce a copolyester/polycarbonate resin composition;
adding an organophosphorus compound (D) to the copolyester/polycarbonate resin composition in an amount of 0.0001 to 1 part by weight based on 100 parts by weight of said copolyester/polycarbonate resin composition; and
melt-kneading the resultant mixture of components (A), (B), (C) and (D).

18. The process according to claim 16, wherein the melt-kneading of the copolyester/polycarbonate resin composition is conducted under vented condition.

19. The process according to claim 17, wherein the melt-kneading of the copolyester/polycarbonate resin composition is conducted under vented condition.

20. A molded product produced from the thermoplastic resin composition according to claim 1.

21. A molded product according to claim 20, wherein said discontinuous phase has a size of 1 to 500 nm after subjecting said molded product to a pressure cooker test under such a condition that the molded product is treated at a temperature of 121° C. and a humidity of 100% under a pressure of 0.20 MPa for 8 hours.

22. A molded product according to claim 21, wherein said discontinuous phase has a size of 10 to 400 nm after subjecting said molded product to a pressure cooker test as defined in claim 21.

23. A molded product according to claim 20, wherein a 3 mm-thick specimen thereof exhibits a haze of not more than 5% after subjecting said molded product to a pressure cooker test under such a condition that the molded product is treated at a temperature of 121° C. and a humidity of 100% under a pressure of 0.20 MPa for 8 hours.

24. A molded product according to claim 20, wherein a 3 mm-thick specimen thereof exhibits an YI value (hue) of not more than 7 after subjecting said molded product to a pressure cooker test under such a condition that the molded product is treated at a temperature of 121° C. and a humidity of 100% under a pressure of 0.20 MPa for 8 hours.
